(19) United States
(12) Patent Application Publication
(10) Pub. No.: US 2012/0079387 A1
(43) Pub. Date: Mar. 29, 2012

(54) CUSTOMIZABLE INTERNET PROTOCOL REMOTE CONTROL

(75) Inventors: Tanmay Agnihotri, San Diego, CA (US); DongWook Kim, San Diego, CA (US)

(73) Assignee: Sony Corporation, Tokyo (JP)

(21) Appl. No.: 12/892,800

(22) Filed: Sep. 28, 2010

(51) Int. Cl. G06F 15/16; G06F 3/048

(52) U.S. Cl. 715/733

(57) ABSTRACT

A system for controlling an electronic device comprising: a server configured to connect to an internet protocol based network and configured to make available a website, wherein the website is configured to allow a user to develop a customized web page for controlling an electronic device, and wherein the server is configured to receive input from the user's customized web page and respond with commands capable of controlling the electronic device.

### FIELD

The present patent document relates to apparatus and processes for controlling electronic devices.

### BACKGROUND

The remote control that is shipped from the factory with most modern day electronic devices often communicates with the electronic device using infrared technology (IR). These remote controls are often extremely complicated and contain numerous buttons. As electronic devices have continued to become more advance and support more functions and functionality, these remotes have become increasingly complicated. Many of the buttons contained on the factory remotes are infrequently used if they are used at all. Most users find themselves only using a select few of the buttons contained on the remote controls that ship with most electronic products.

In addition to the remote controls that come shipped with most electronic products, universal remote controls are also available. Universal remote controls can be programmed to control a plurality of electronic devices. Because these remote controls must control multiple devices, they may be even more complex than the remote controls that come with the electronics from the factory.

Furthermore, every user is unique and may use different aspects of their electronic device regularly. If the particular functions of the electronic device the user frequently uses do not have a dedicated button on the native remote control, the user experience may be frustrated by constantly having to push multiple buttons to perform the most frequently used functions.

### SUMMARY OF THE EMBODIMENTS

In view of the foregoing, an object according to one aspect of the present patent document is to provide an improved apparatus and process for controlling an electronic device with a remote control. Preferably the apparatus and process address, or at least ameliorate one or more of the problems described above. To this end, a system for controlling an electronic device is provided. In one embodiment the system comprises: a server configured to connect to an internet protocol based network and configured to make available a website, wherein the website is configured to allow a user to develop a customized web page for controlling an electronic device, and wherein the server is configured to receive input from the user's customized web page and respond with commands capable of controlling the electronic device.

In another embodiment, the server is hosted on the electronic device to be commanded. In a particular embodiment, the electronic device hosting the server is a television. In other embodiments, more than one electronic device may be controlled from the customized web page.

In yet another embodiment, the internet protocol (IP) based network is the Internet. In other embodiments, the IP based network may be a local LAN or WAN. In some embodiments, the connection to the IP network may be wireless and in other embodiments the connection may be wired. In another embodiment, the web page is specially configured to be displayed on a phone.

In another embodiment, the server is configured to provide an option to translate the customized aspects of the web page into an executable designed to run on a portable electronic device.

In yet another embodiment, an electronic device designed to be controlled by a customized remote is provided; the electronic device comprising: a transceiver capable of connecting to an internet protocol based network; a processor; and a firmware designed to run on the processor and command the processor to receive communications from the transceiver and translate the communications received from the transceiver into commands commonly received via a factory shipped remote.

In certain embodiments, the firmware is further designed to run a hypertext transfer protocol (HTTP) server. In another embodiment, the firmware is designed to host a customizable web page on the server, wherein the customizable web page is configurable to control the television.

In another embodiment, a television is provided; the television comprises: a transceiver designed to connect to an internet protocol based network; and a processor configured to host a hypertext transfer protocol server via the transceiver and serve a customizable web page that is configurable to control the television. In certain embodiments, the customizable web page is specifically configured to be displayed on a phone.

In yet another embodiment, a method of controlling a television is provided; the method comprises: serving a customizable web page from a hypertext transfer protocol server hosted on the television; and translating input received from the hypertext transfer protocol server into a command for the television.

In certain embodiments, the customizable web page has links to other customizable web pages.

### BRIEF DESCRIPTION OF THE DRAWINGS

FIG. 1 illustrates a system for customizable control of an electronic device via an internet protocol based network.

FIG. 2 illustrates a system for customizable control of a plurality of electronic devices via an internet protocol based network.

FIG. 3 illustrates a television designed to serve a customizable web page configurable to control the television.

FIG. 4 illustrates a flow chart for controlling an electronic device via a customizable web page.

### DETAILED DESCRIPTION OF THE EMBODIMENTS

Consistent with its ordinary meaning, the term “web page” is used herein to refer to any collection of code or computer instructions that may be interpreted and displayed by a browser over a communication network such as the world wide web. It is not important that the collection of code actually be transferred over the communication network but only that it is capable of the transfer. “Web page” includes collections of code designed using a language intended for use with the world wide web and other communication networks. By way of non-limiting example, “web page” includes collections of instructions in hypertext markup language (HTML), PHP, Flash, C, Java, JavaScript, and any other language capable of interpretation and display by a web browser.

Consistent with its ordinary meaning, the term “server” is used herein to refer to any electronic device designed to listen over a communication network and respond to requests directed to its unique identifier. A server includes any central processing unit (CPU) connected to a communication network listening for requests directed to its Internet Protocol (IP) address. A server includes a hypertext transfer protocol server running on an IP based network. By non-limiting example “server” includes a CPU running Apache or any Microsoft Server operating system or any other server designed to listen on specific software ports for communication requests.

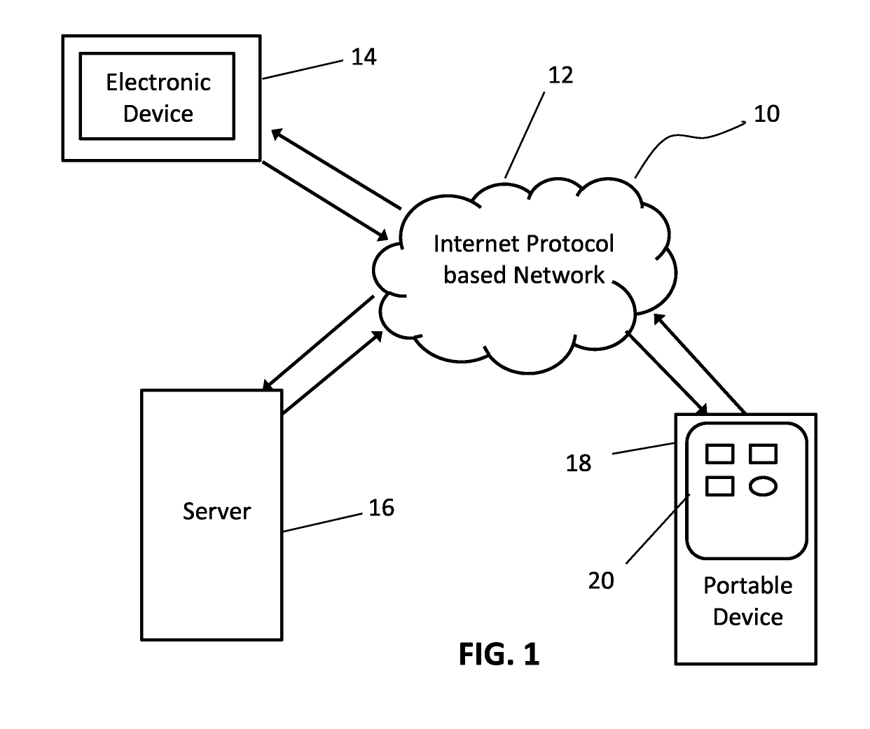

FIG. 1 illustrates a system 10 for customizable control of an electronic device 14 via an internet protocol based network 12. A server 16 provides the user with a customizable web page 20 that allows the user to easily configure controls for the functions the user most frequently uses on the electronic device 14. By providing a customizable web page 20, a user may control the electronic device 14 with an interface specifically designed for the user. In addition, by using an internet protocol based network 12, the user is no longer required to be in close proximity with the electronic device 14 to control it.

The embodiment of FIG. 1 comprises a server 16, a portable device 18, and an electronic device 14. As shown in FIG. 1, the server 16, portable device 18, and electronic device 14 communicate via a network 12 based on the internet protocol. Although in the embodiment displayed in FIG. 1 a network 12 based on the internet protocol is shown, the communication network 12 may be any packetized network capable of allowing communication between devices. For example, the network 12 could be based on token ring, asynchronous transfer mode (ATM), Bluetooth®, or any other packet based protocol including protocols that support data transfer to cell phones such as 3G and Edge.

In addition to the network 12 being based on numerous different technologies, the network may also be any size or shape. For example the network 12 may be the Internet, or the network 12 may be a home local area network (LAN) or business or office LAN. The network 12 includes all size networks including the Internet, intranets, LANs and wide area networks (WANs) of all shapes and sizes.

The server 16, electronic device 14, and portable device 18, may be connected to the network 12 by a wired connection or a wireless connection. In one embodiment, the wireless connection is based on IEEE 802.11, however, other wireless protocols may be used including Bluetooth®, 3G, EDGE, or any other wireless protocol.

In a preferred embodiment, the server 16 is a hypertext transfer protocol (HTTP) server. The server 16 provides access to a web page 20 that a user may configure to control an electronic device 14. However, the server may be based on other internet communication protocols such as Adobe's Flash®, PHP, Java®, Javascipt, or any other protocol adapted for communication over a data network 12.

The operation of the system 10 will now be described while referring to the embodiment illustrated in FIG. 1. A user of the system first requests the web page 20 from the server by entering a universal reference locator (URL), clicking on a link, or other method of locating a resource on a data network via the portable device 18. The server subsequently provides the requesting user with access to the web page 20.

The web page 20 may take on many shapes and sizes. The web page 20 may have already built customizable templates for certain electronic devices 14 or the web page 20 may allow the user to start from scratch building a customized interface for the electronic device 14.

In a preferred embodiment the web page 20 is configurable to include any buttons or controls the user wishes to have to control an electronic device 14. Controls on the web page 20 may include sliders, radio buttons, regular buttons and any other type of custom dial or button that may be created or developed through software. For example, rather than using individual buttons for up and down to control volume like on a normal remote control, a slider may be provided on the web page 20 to allow the user to have more efficient control of the volume.

In general, any type of custom button or input mechanism may be developed in software and used to control the input device. Development languages such as Adobe's Flash® and other languages allow developers to create unlimited custom buttons and controls. In a preferred embodiment, custom buttons and controls are available for integration into the web page 20.

The web page may further include a selection area for the user to select the type of electronic device 14 that is intended to be controlled by the web page 20. For example, drop down lists that filter through manufactures and models may be initially provided on web page 20. Based on the electronic device 14 the user selects as the intended device to be controlled, the web page 20 may then present the user with a number of default controls and buttons. The server may pull the default buttons and controls configuration from an internal database or from an external manufactures database. For example, in one embodiment after the user selects the intended electronic device 14 for control, the web page 20 may show the user a default template for that particular electronic device 14. The user may subsequently drag and drop additional controls on the default device and/or delete unwanted controls.

In a preferred embodiment, the web page 20 allows the user to hide controls under other controls in the form of links to form control hierarchies. When the user selects a link for a control hierarchy a new customizable web page 20 may be displayed much the same way web pages are linked. By creating control hierarchies, the user may hide the controls that are not often used and display the controls that are frequently uses. In general, web page 20 is not restricted to a single web page and in a preferred embodiment includes numerous web pages linked together.

In a preferred embodiment, the web page 20 may be based on Adobe's Flash® technology. Flash® is particularly adapted to allow interaction with users via a web page 20 and supports drag and drop functionality and other advanced interaction that make it ideal for development of the web page 20. However, Flash® is not supported on all devices and consequently as noted above the web page 20 may be made using other languages such as C, PHP or Java®.

The portable device 18 may be any device capable of connecting to the server and viewing the customizable web page 20. For example, any portable device with a display and the ability to connect to the network 12 may be used. In a preferred embodiment, the portable electronic device is a cell phone such as an iPhone®, Blackberry® or Droid®. However, the portable electronic device may be any device capable of displaying the web page 20 such as a laptop, iPad®, eReader or any other portable device 18. In a preferred embodiment, the web page 20 is specifically customized for display on a specific portable device such as a particular phone or tablet.

Once the user has customized the web page 20, the web page 20 may be used to control the electronic device 14 from the portable device 18 via the communication network 12.

The server 16 that is hosting the web page 20 may be located in any number of locations. For example, although the server 16 is shown as a separate element from the electronic device 14 in the embodiment of FIG. 1, preferably the server 16 is running on the electronic device 14 that it is being controlled. However, the server 16 could be a local server or remote server connected to the electronic device 14 via a data network 12 as shown in FIG. 1. The operation of different embodiments of the system 10 with the server 16 located in different locations is described below.

In one embodiment where the server 16 is located remotely from the electronic device 14, the user selects a control on the web page 20 and the server 16 responds to the selection with the appropriate command encapsulated in a datagram. The web page 20 running on the portable device 18 receives the command from the server 16 and forwards the command to the electronic device 14 that is being controlled. When the server 16 replies to the web page 20 with the command, and the web page 20 forwards the command to the electronic device 14, the electronic device 14 is only required to be on a local network with the portable device 18 displaying the web page 20.

However, rather than the portable device 18 forwarding the command to the electronic device 14, other embodiments may send the command directly to the electronic device 14. For example, the server 16 may send the command directly to the electronic device 14 via the communication network 12. If this network 12 is the Internet, the electronic device 14 would be required to be connected to the Internet. When the user selects a button on the web page 20, the server 16 is notified of what button the user has selected. The server 16 then encapsulates the appropriate command for the electronic device 14 in a datagram and sends the datagram directly to the electronic device 14 via the communication network 12.

In embodiments where the server 16 is located remotely from the electronic device 14, it is beneficial to use encryption and/or authentication to establish the connection between the server 16 and the electronic device 14. Encryption and/or authentication will help prevent a security breach which may result in control of the electronic device 14 by someone without authorization.

In a preferred embodiment, the server 16 may reside within the electronic device 14 selected for control. In such an embodiment, the web page 20 sends an input to the server 16 indicating which control or button the user has selected. Because the server 16 is residing on the electronic device 14 that needs to be controlled, the server 16 simply decodes the command and passes it to the firmware of the electronic device 14 for execution.

In a preferred embodiment, the server 16 residing on the electronic device 14 decodes the command and injects the command into the firmware of the electronic device 14 as if the command had come from the factory provided IR remote.

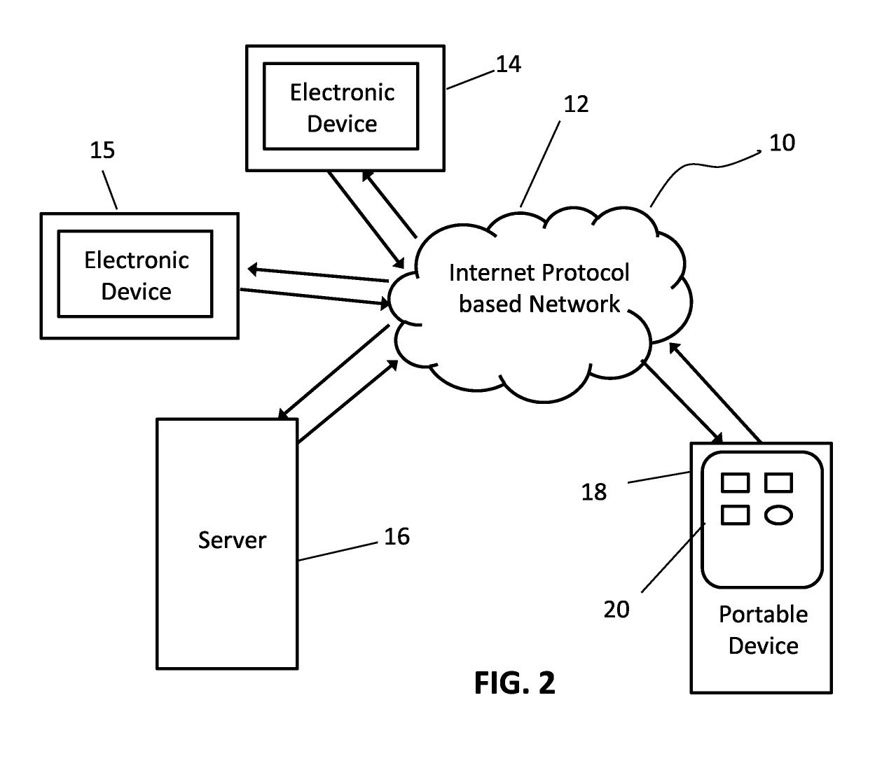

FIG. 2 illustrates a system 10 for customizable control of a plurality of electronic devices 14 and 15 via an internet protocol based network 12. The embodiment of FIG. 2 shows a system 10 that controls two electronic devices 14 and 15, however, any number of electronic devices may be controlled.

In an embodiment where more than one electronic device 14 and 15 are controlled, the user may add control buttons for each device on the same customizable web page 20 or the user could have separate web pages 20 for each electronic device 14 and 15 with a button on each web page 20 to link between the separate web pages 20. The buttons or controls on the web page(s) 20 would keep track of which device the buttons or controls were associated with so that the commands are routed to the correct electronic device 14 or 15. For example, each of the buttons may be associated with the IP address of their corresponding electronic device 14 or 15 so that upon execution the command is routed through the network 12 to the correct device.

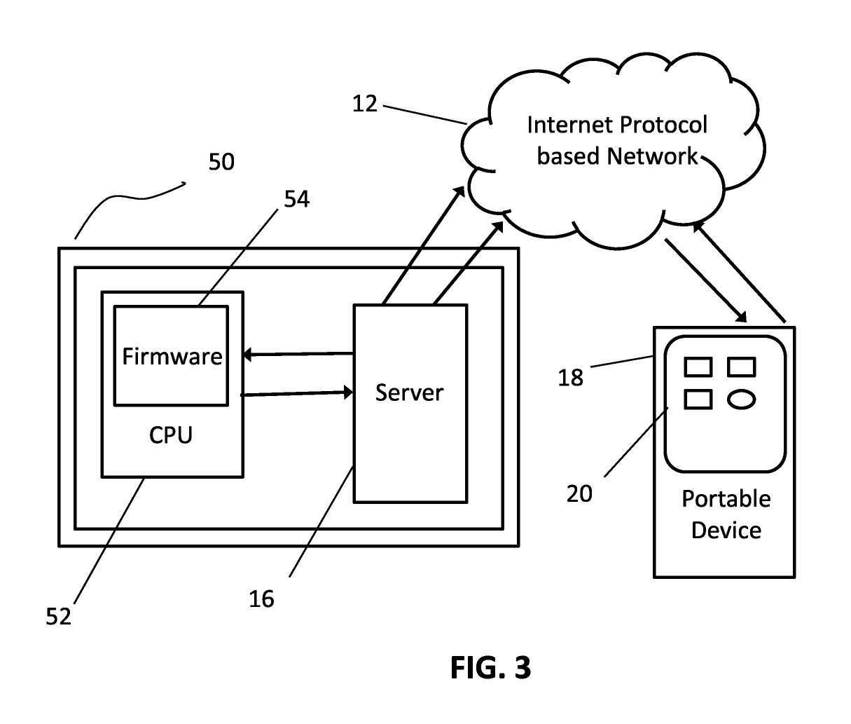

FIG. 3 illustrates a television 50 designed to serve a customizable web page 20 configurable to control the television 50. As is shown in FIG. 3, the server 16 may reside within the electronic device. In the embodiment shown in FIG. 2, the television 50 includes a processor 52. The processor 52 includes firmware 54 that enables the processor 52 to run a server 16.

While FIG. 3 illustrates a television 50 as the electronic device being controlled, any electronic device may be controlled via the customizable web page 20. For example the electronic device may be a DVD player, VCR, Blu-ray® disk player, stereo receiver, home theater system or any other electronic device.

One advantage to the television 50 or other electronic device hosting its own server 16 is that network 12 may be a local network such as a home LAN. Using a local network reduces security concerns, reduces complexity, and increases connectivity. Furthermore, the server 16 hosted on the television 50 allows the commands received by the server 16 to be injected directly into the firmware 54 as if the commands came from a factory supplied IR remote. Injecting the commands directly into the firmware 54 simplifies implementation and increases reliability and performance.

Furthermore, hosting the server within the electronic device to be controlled limits the amount of customization the server 16 has to support with respect to the web page 20. Because the server 16 only has to support control for the device its hosted on, the server 16 does not need information about how to control other devices.

However in another embodiment, the web page 20 being hosted by a server 16 within the electronic device may be customized to control more than one electronic device. The web page 20 may allow the user to link to other electronic devices. When the user selects the link the portable device 18 would send a request to another server located on another electronic device and a new web page 20 would be displayed. In this embodiment multiple electronic devices, all running their own web server, may be accessed and controlled by the portable device 18. In a preferred embodiment, a standard is developed and implemented to ensure compatibility of the switching between the web servers of the various devices through their customizable web pages 20.

In an alternative embodiment, the server 16 may provide an executable application specifically designed for operation on a portable device 18, based on the user's configuration of the customizable web page 20. After the user has customized the web page 20 according to their liking, the user may request an executable application for use on a particular portable device 18 based on the configuration of the customizable web page 20. The server 16, may then convert the user's configurations into an executable application for use on a particular portable device 18. The user may then control the television 50 or other electronic device 14 via the portable device without interaction from the server 20. The user may download the executable application directly to the portable device 18 for future use. The customizable application may then be executed on the portable device 18 to provide control of the television 50 or other electronic device 14 via a network 12. If the user wishes to make changes to the executable application running on the portable device 18, the user may browse back to the server 16, make the changes on the customizable web page 20 and download an updated executable from the server 16.

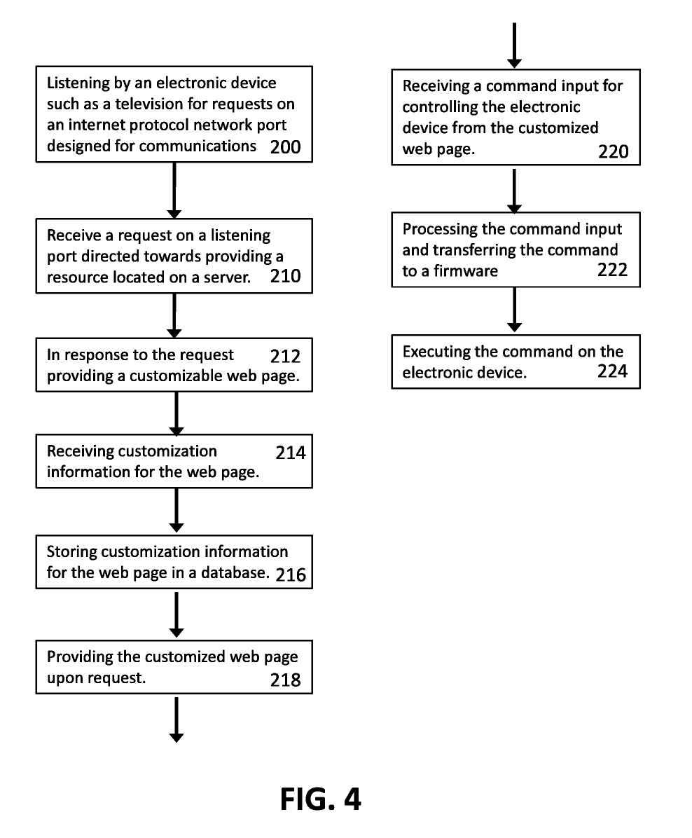

FIG. 4 illustrates a flow chart for controlling an electronic device via a customizable web page. The process is initiated by step 200. The electronic device listens for requests on an internet protocol network port. The most common port is port 80 which is recognized as the port for HTTP. However, any port may be used and the electronic device may be set up to listen on a special proprietary port.

Once the electronic device receives a request 210 the electronic device provides a customizable web page 212. A series of back and forth transactions then takes place as the user customizes the web page 214. The server must store these customizations so the web page may be subsequently displayed in its customized form. The server may store the customization information locally in a database or externally on another database server 216. When a subsequent request for the web page is received by the server the server must provide the customized web page 218.

The customized web page contains a number of buttons and controls that equate to specific functions on the electronic device or links to other buttons and controls. In addition, buttons and controls may be associated with a specific electronic device so that multiple electronic devices may be controlled from the same web page. Associate of the buttons to an electronic device is preferably done with the IP address of the electronic device but other methods may be used including association with the MAC address or any other unique identifier.

The placement, quantity, and style of the buttons and controls are user selected through the customization process. When the user selects any one of the buttons or controls on the web page the server receives the command 220 and processes the command by passing it onto the firmware of the electronic device 222. The command is then executed on the electronic device 224.

Although the embodiments have been described with reference to preferred configurations and specific examples, it will readily be appreciated by those skilled in the art that many modifications and adaptations of the methods, and systems for controlling a electronic device described herein are possible without departure from the spirit and scope of the invention as claimed hereinafter. Thus, it is to be clearly understood that this description is made only by way of example and not as a limitation on the scope of the invention as claimed below.

What is claimed is:

1. A system for controlling an electronic device comprising:
a server configured to connect to an internet protocol based network and configured to make available a website, wherein the website is configured to allow a user to develop a customized web page for controlling an electronic device, and wherein the server is configured to receive input from the user's customized web page and respond with commands capable of controlling the electronic device.

2. The system of claim 1, wherein the server is hosted on the electronic device.

3. The system of claim 1, wherein the electronic device is a television.

4. The system of claim 1, wherein the internet protocol based network is the Internet.

5. The system of claim 1, wherein the web page is specially configured to be displayed on a phone.

6. The system of claim 1, wherein the server is configured to provide an option to translate the customized aspects of the web page into an application designed to run on a portable electronic device.

7. The system of claim 1, wherein the server is configured to connect to the internet protocol based network via a wireless connection.

8. The system of claim 1, wherein the web page may be configured to control more than one electronic device.

9. An electronic device designed to be controlled by a customized remote, the electronic device comprising:
a transceiver capable of connecting to an internet protocol based network;
a processor; and
a firmware designed to run on the processor and instruct the processor to receive communications from the transceiver and translate the communications received from the transceiver into a subset of commands wherein the commands are subsequently processed by the firmware the same way commands coming from a remote control are processed by the firmware.

10. The electronic device of claim 9, wherein the electronic device is a television.

11. The electronic device of claim 9, wherein the firmware is designed to run a hypertext transfer protocol server.

12. The electronic device of claim 11, wherein the firmware is designed to host a customizable web page on the server, and wherein the customizable web page is configured to control the television.

13. The electronic device of claim 9, wherein the transceiver is configured to connect to the internet protocol based network via a wireless connection.

14. A television comprising:
a transceiver designed to connect to an internet protocol based network; and
a processor configured to host a hypertext transfer protocol server via the transceiver and serve a customizable web page that is configurable to control the television.

15. The television of claim 14, wherein the customizable web page is specifically configured to be displayed on a phone.

16. The television of claim 14, wherein the transceiver is designed to connect to the internet protocol based network via a wireless connection.

17. The television of claim 14, wherein the customizable web page is configurable to link to a web page of another electronic device.

18. A method of controlling a television, the method comprising:
serving a customizable web page from a hypertext transfer protocol server hosted on the television;
translating input received from the hypertext transfer protocol server into a command for performing a function of the television;

19. The method of claim 18, further comprising the step of serving a second customizable web page based on a request received from the customizable web page.
